(19) United States
(12) Patent Application Publication
(10) Pub. No.: US 2004/0071275 A1
(43) Pub. Date: Apr. 15, 2004

(54) Telephone call handling solution in an interactive voice response system

(75) Inventors: Ronald John Bowater, Romsey (GB); Adam Pieter de Leeuw, Southampton (GB); David Seager Renshaw, Winchester (GB); Samuel Jonathan Smith, Southampton (GB)

Correspondence Address: IBM Corp, IP Law Dept T81/503, 3039 Cornwallis Road, PO Box12195, Research Triangle Park, NC, 27709-2195, US

(73) Assignee: International Business Machines Corporation, Armonk, NY

(21) Appl. No.: 10/436,964

(22) Filed: May 13, 2003

(30) Foreign Application Priority Data
Oct. 10, 2002 (GB) 0223549.7

(51) Int. Cl. H04M 11/00; H04M 1/64

(52) U.S. Cl. 379/88.18; 379/88.25; 379/88.17

(57) ABSTRACT

A call handling solution for IVR applications with embedded components. A method of handling an incoming call in a network connected interactive voice response system (IVR), comprising the steps of: receiving a signal indicating an incoming telephone call with a call identification (CLID); retrieving, from a database, a database record associated with the call identification; retrieving, from a network location identified in the retrieved record, at least one VoiceXML application identified in the retrieved record; storing the retrieved at least one VoiceXML into cache memory; and answering the incoming telephone call.

### FIELD OF INVENTION

This invention relates to a method, apparatus and computer program product for a call handling solution in an interactive voice response system (IVR). In particular it relates to a call handling solution for IVR applications with embedded components.

### BACKGROUND OF THE INVENTION

A telephone can be used to place a catalogue order; check an airline schedule; query a price; review an account balance; notify a customer; record and retrieve a message; and many other business interactions. Often, each telephone call involves a service representative talking to a caller, asking questions, entering responses into a computer, and reading information to the caller from a terminal screen. This process can be automated by substituting an IVR with an ability to play voice prompts and receive user input e.g. from speech recognition or from DTMF tones.

The interaction of the voice prompts and user input is guided by a voice application that in turn is executed by the IVR. Voice applications have been written in script, state code, and *Java. Now demand for internet compatibility has introduced voice extensible mark up language (VoiceXML). *Java and all Java based trademarks and logos are trademarks or registered trademarks of Sun Microsystems, Inc in the United States, other countries or both.

VoiceXML is an emerging technology in the current telephony IVR market. VoiceXML is a markup language that is defined as a standard by representatives in the telephony market and grew from extensible markup language (XML). XML was developed by the Worldwide Web Consortium. Through the use of customised tags XML offers greater flexibility in organising and presenting information than is possible with other mark up coding systems. VoiceXML defines a new set of XML ‘tags’ that can be used to write voice response applications and it simplifies speech application development by using familiar web infrastructure, including web pages, web tools and web servers.

Voice applications in the form of web pages are fetched and interpreted by a VoiceXML enabled browser that invokes the actions defined in the web page by the VoiceXML tags, e.g. play prompt; get DTMF; do voice recognition; play text-to-speech string etc. This allows people to embed VoiceXML tags in their existing HTML pages and effectively have a single source for both text and telephony based interaction with a server side application. The pages are simply served up to an IVR from a standard web server using the HTTP protocol in the same way as HTML pages would be. VoiceXML components such as a voice prompts are embedded in the VoiceXML application.

The increasing influence of the world wide web on telephony technology means that voice applications and application components become increasingly distributed. A IVR may not only use locally and corporately stored applications but also publicly available IVR applications and application components stored anywhere on the Internet. As more people start to use VoiceXML technology to allow users to interact with their web pages, IVRs will be put under increasing pressure to fetch ‘web-pages’ from a remote web server. Distributed web servers impact the performance of the IVR and causes delays to callers when pages are being fetched.

### DISCLOSURE OF THE INVENTION

According to a first aspect of the present invention there is provided a method of handling an incoming call in a network connected interactive voice response system (IVR), comprising the steps of: receiving a signal indicating an incoming telephone call with a call identification; retrieving, from a database, a database record associated with the call identification; retrieving, from a network location identified in the retrieved record, at least one IVR application identified in the retrieved record; storing the retrieved at least one IVR application into cache memory; and answering the incoming telephone call.

Such an association of an IVR application name with a call identification allows for pre-caching of the IVR applications. With this solution when a call is being handled and a caller is interacting with the IVR there is no delay during such interaction associated with the IVR needing to retrieve IVR files from over a network. This is because a selection of the caller's favourite applications are already stored in the cache or, in the situation where the application or component are not identified in the cache, they are retrieved from the network prior to an IVR application being selected by the caller. Furthermore, there will be no delay when further cached IVR applications are used.

Advantageously, the step of retrieving comprises locating an application name in a record used in a previous IVR interaction with respect to the call identification so that the voice interaction history of the CLID (calling line identification) is used as a guide to which applications are pre-fetched. Adding a new IVR application name to the record when said new IVR application is involved in the call interaction and not already in the record associated with the call identification allows continuous updating of the CLID record.

Preferably only a subset of IVR applications named in the record are retrieved so that pre-fetching is only used on important or much used IVR applications. By updating a count value associated with a IVR application name when the IVR uses the IVR application, the IVR can keep track of which IVR applications are used the most. The subset of IVR applications fetched can depend on the count value associated with each application name.

Suitably the at least one IVR application comprises at least one VoiceXML application.

The IVR application components may also be treated in the same way as IVR applications as the name is the same URI protocol. For instance IVR component names may be stored in the CLID record along with IVR application names. Alternatively the IVR application can be parsed after retrieval to identify application component names.

Most advantageously, the caller's most favourite IVR application can be launched immediately and without prompting.

According to a second aspect of the invention there is provided a system for handling calling in an interactive voice response system (IVR) as described in the claims.

According to a third aspect of the invention there is provided a computer program product for processing one or more sets of data processing tasks in an interactive voice response system (IVR) having cache memory as described in the claims.

### BRIEF DESCRIPTION OF THE DRAWINGS

To promote a fuller understanding of this and other aspects of the present invention, an embodiment of the invention will now be described, by means of example only, with reference to the accompanying drawings in which:

FIG. 1 is an overview of a voice response system and web servers;

FIG. 2 is a schematic view of the voice response system of a preferred embodiment of the present invention;

FIG. 3 is a schematic view of the method of the preferred embodiment of the present invention;

FIG. 4A is a schematic diagram of a file cache of a preferred embodiment of the present invention; and

FIG. 4B is a schematic diagram of a database of a preferred embodiment of the present invention.

### DESCRIPTION OF THE PREFERRED EMBODIMENTS

The preferred embodiment of the present invention is implemented using IBM* WebSphere* Voice Response (WVR) for AIX* with DirectTalk* Technology v3.1 as the base interactive voice response system (IVR). WVR is well-suited for large enterprises or telecommunications businesses. It is scalable, robust and designed for continuous operation 24 hours a day and 7 days a week. WVR for AIX can support between 12 and 480 concurrent telephone channels on a single system. Multiple systems can be networked together to provide larger configurations. *AIX, DirectTalk, IBM pSeries, and WebSphere are trademarks of International Business Machines in the United States, other countries, or both.

WVR for AIX supports from 1 to 16 E1 or T1 digital trunks on a single IBM pSeries* server with up to 1,500 ports on a single system. Up to 2304 telephony channels using T1 connections or 2880 telephony channels using E1 connections can be supported in a 19″ rack. Applications can be written in Java, VoiceXML and native code. WVR runs uinder an IBM AIX v 4.3 operating system running on an IBM pSeries computer. It supports network connectivity on multiple networks including PSTN, ISDN, CAS, SS7, VoIP networks. The preferred embodiment is concerned with those networks that provide a caller identification number with an incoming call e.g. ISDN and SS7. SS7 is often employed for IVRs within the telephony network, for example telecoms providers who wish to provide value add facilities that require IVR functionality. Such applications are typically on a large scale.

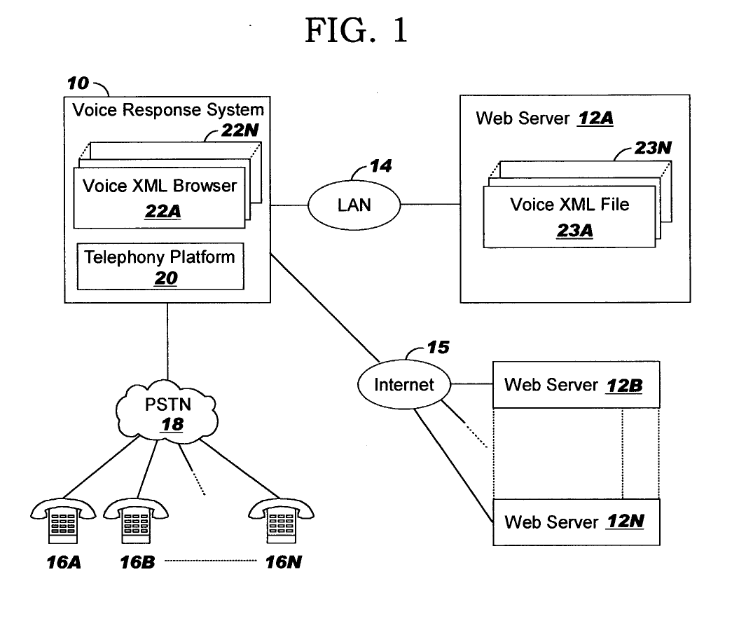

Referring to FIG. 1, there is shown an IVR 10 connected to any one of a plurality of web servers 12A . . . 12N through a LAN 14 or the Internet 15. The IVR 10 may also connect to any one of a plurality of telephones 16A . . . 16N through a telephony network 18. In a general overview the IVR 10 comprises a telephony platform 20 and voiceXML browsers 22A . . . 22N. The telephony platform handles the communication between the IVR 10 and the telephones 16A . . . 16N. A VoiceXML browser 22A executes one VoiceXML file, e.g. VoiceXML application 23A stored on web server 12A. The VoiceXML browser 22A interacts with the caller under the control of the VoiceXML application 23A.

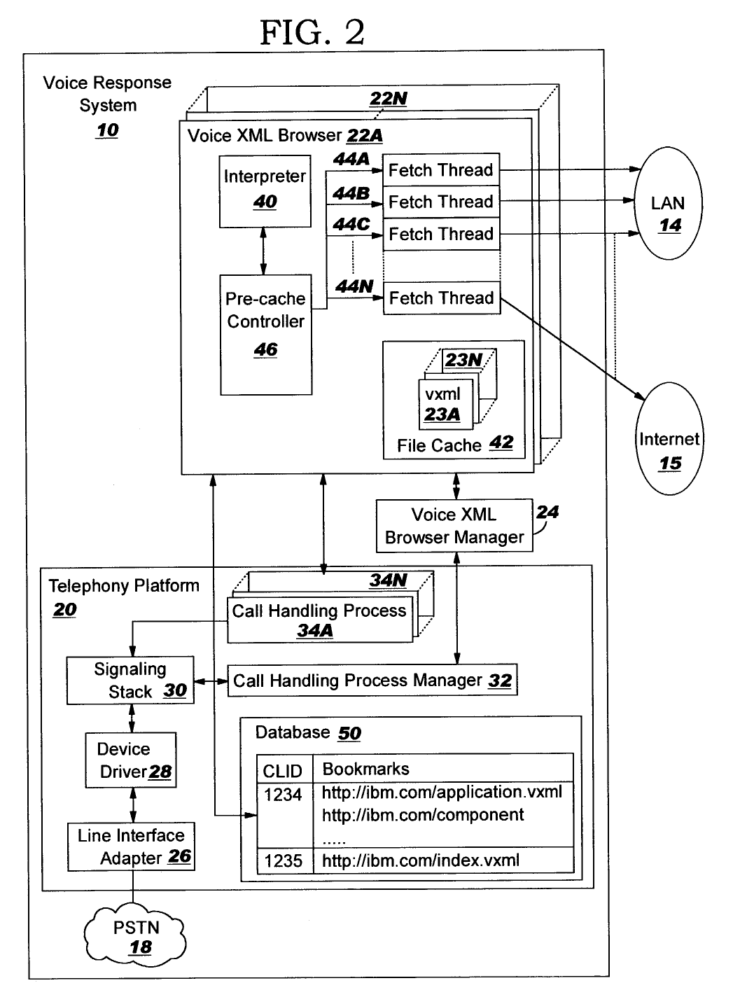

In more detail and with respect to FIG. 2, telephony platform 20 of IVR 10 comprises: line interface adapter 26; device driver 28; signalling stack 30; call handling process manager 32 and database 50. IVR 10 further comprises VoiceXML browsers 22A . . . 22N and VoiceXML browser manager 24.

A VoiceXML browser 22A comprises: interpreter 40; file cache 42; multiple fetch threads 44A . . . 44N; and pre-cache controller 46.

The line interface adapter 26 provides the physical means by which the IVR 10 is connected to any one telephone 16A . . . 16N on PSTN telephone network 18.

The device driver 28 communicates between the line interface adapter 26 and the signalling stack 30.

The signalling stack 30 communicates with the far end telephone switching equipment over the physical transport layer. It communicates via device driver 28 and line interface card 26 to send and receive signalling status information. The status information describes the state of the telephone lines, that is, ringing, on-hook, off-hook etc. The signalling stack 30 implements the same specific communications protocol as the far end switching equipment to enable bi-directional communications. The signalling stack 30 communicates with the line interface adapter 26 via the device driver 28 for operations such as incoming call detection and making outbound calls. It communicates with the call handling process manager 32 by placing messages in shared memory segments that can be accessed by all software components in the voice response system.

The call handling process manager 32 connects an incoming call to an available call handling process e.g. 34A. When an incoming call is detected by the signalling stack 30, the call handling process manager 32 is notified and identifies call handling process 34A for the duration of the call. Although only one call handling process 34A is described here, an order of 480 call handling processes 34A . . . 34N are managed by the call handling process manager 32 in the preferred embodiment.

A call handling process 34A manages a single telephone call on a single telephone channel. In operation there are many open telephone channels in a voice response system; the call handling process manager 32 monitors the state of each telephone channel using its associated call handling process.

When the system is started, the call handling process manager 32 initiates enough call handling processes 34A . . . 34N to service all the available configured telephone channels. The call handling process manager 32 ensures that calls can always be serviced even if all telephone channels are active at the same time.

Call handling process 34A moves from an available state into an active state once it is assigned to handle a telephone call on a particular line. Once a call and IVR application has completed, the associated call handling process 34A moves back from an active to an available state in readiness to service another call. Call handling process 34A communicates with the VoiceXML browser 22A to invoke the actions as defined by a VoiceXML application 23A by interacting with other components in the IVR 10. Messages are sent using sockets between the call handling processes and the VoiceXML browser 22A. Once a call is terminated, the call handling process 34A notifies the call handling process manager 32 of this and returns to a state of availability.

The VoiceXML browser manager 24 co-ordinates the activities of VoiceXML browsers 22A . . . 22N. It accepts a request from a call handling process 34 to be connected to VoiceXML application 23A and tracks the usage and availability of the browsers. When a call arrives at the system and call handling process 34A has been assigned to handle the call, the VoiceXML browser manager 24 is asked by the call handling process 34A to provide an instance of a VoiceXML browser to service the call. One VoiceXML browser generally corresponds to one call handling process.

VoiceXML browsers 22A . . . 22N are software browsers that can be used to run voice applications that are defined in VoiceXML. A VoiceXML browser is similar to browser products like Netscape Navigator or Internet Explorer except that it uses a voice markup language instead of a text markup language such as HTML. VoiceXML documents contain XML elements that can be used to specify an application command e.g. Play prompt, get DTMF input, play text-to-speech etc.

VoiceXML browser 22A fetches, interprets and executes the VoiceXML files 23A . . . 23N. VoiceXML files 23A . . . 22N include VoiceXML applications (e.g. 23A) and VoiceXML components to which links are formed in the applications.

A single VoiceXML browser 22A services a single call on a single telephone channel. When a request is made by the VoiceXML browser manager 24 for a browser 22A to service a telephone call, the browser 22A moves from the available to the active state. The VoiceXML browser manager 24 will not then try to assign that instance of the VoiceXML browser 22 to service another call. Once the call and application have completed, the VoiceXML browser 22A moves from the active to the available state in readiness to service another call.

The interpreter 40 parses and validates the VoiceXML files 23A . . . 23N defining the application and application components. The interpreter 40 does this against the DTD (Document Type Definition) that is defined for the VoiceXML specification and also initiates the actions required by the VoiceXML document in the underlying voice response system. This is achieved through communication with the call handling process 34A that has been assigned to the VoiceXML browser 22A.

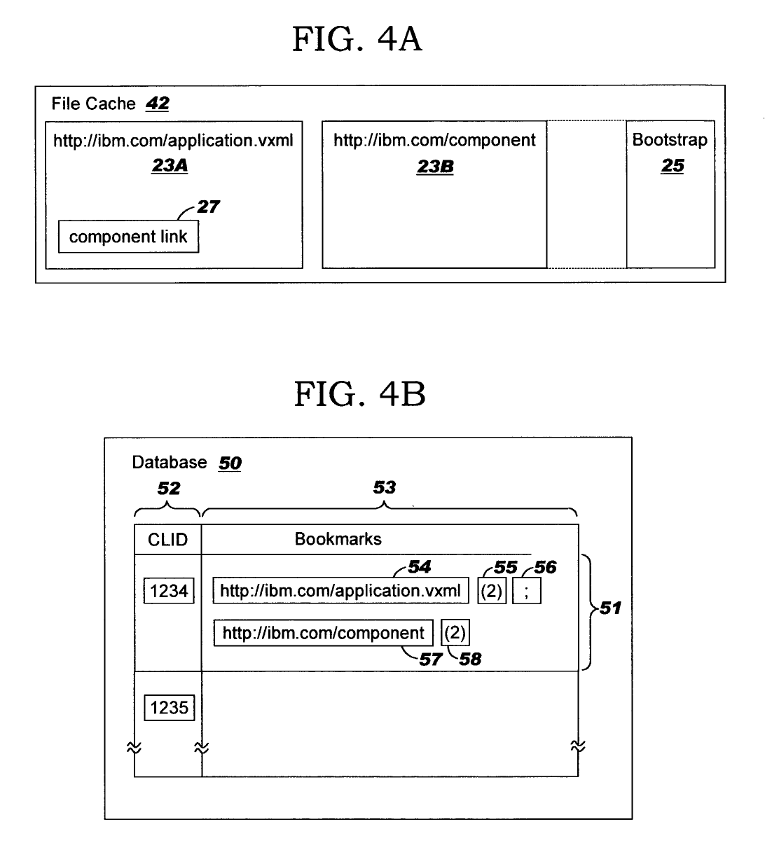

The file cache 42 stores VoiceXML files 23A . . . 23N in the IVR 10 local file system or reserved memory. The file cache 42 honours file expiry times that can be specified in VoiceXML files 23 and will re-fetch cached VoiceXML files once they have expired. Referring to FIG. 4A there is shown file cache 42 with VoiceXML files: application 23A; application component 23B; and bootstrap IVR application 25. Application 23A and application 24B are the VoiceXML files downloaded from Web server 12A (FIG. 1). Application 23A comprises a URI link 27 for application component 23B. In this case URI link 27 is the address of the web server and file name of the VoiceXML component ‘http://ibm.com/component’. The bootstrap IVR application 25 is normally the first IVR application to run when an incoming call is answered. The bootstrap IVR answers the call and prompts the caller to choose another IVR application to run from a list of possible IVR applications, most probably including the bookmarked IVR applications and some other IVR applications. Furthermore, in the preferred embodiment, it is under the control of the bootstrap IVR that visited URIs are logged and database 50 updated. In another embodiment, the bootstrap IVR application will pass control over to a most favourite IVR application without prompting the call to choose.

A fetch thread 44A (FIG. 2) is part of the VoiceXML browser 22A that obtains a VoiceXML file 23A from one of the web servers 12A . . . 12N. It uses the standard HTTP protocol to retrieve the VoiceXML file and stores it locally in the file cache 42. The fetch thread 44A will automatically check whether a document is already available in the file cache (and hasn't expired) before going out to the URI (Univeral Resource Indicator) specified to retrieve the document to improve performance of the system.

The database 50 in the telephone platform 20 records relationships between Calling Line Identifiers (CLID) and VoiceXML file URIs and is shown in more detail in FIG. 4B. In the preferred embodiment, a single record 51 in database 50 comprises: an identifier field 52 of fixed length for the CLID and a URI field 53 capable of variable length for a bookmark list of URIs associated with the CLID. In this example, the URI field 53 comprises: URI 54 for VoiceXML application 23A; visit counter 55; separator 56; URI 57 for VoiceXML component 23B and visit counter 58. URI 54 comprises the server path ‘http://ibm.com/’ and the VoiceXML file name ‘application.vxml’ that enable a fetch thread to find and retrieve the VoiceXML application. URI 57 comprises the server path ‘http://ibm.com/’ and VoiceXML file name ‘component’. Visit counter 55 stores the number of times that the browser uses the URI 54 in the interaction and visit counter 58 stores the number of times that the browser uses the URI 57 in the interaction. In another embodiment a single record is identified by the URI and further fields comprise the visit counter and the associated CLID. The database 50 can be interrogated to retrieve information and can also be updated to reflect changes in the caller's most often accessed files. Each VoiceXML URI identifies an VoiceXML application or a component of an application.

In the preferred embodiment records in database 50 contains URIs for each VoiceXML application associated with a CLID and also for each VoiceXML component within each VoiceXML application. This allows both applications and application components to be retrieved from remote servers at the same time. In another embodiment the record contains only URIs for VoiceXML applications and the interpreter 40 has to parse the fetched VoiceXML applications for application component URIs and then dispatches further fetch threads via the pre-catch controller. This reduces the size of the database needed as it stores only application files but still has the advantage of caching VoiceXML components albeit after the application has been fully downloaded and parsed.

The pre-cache controller 46 queries and updates records in database 50. It also dispatches fetch threads 44A . . . 44N to retrieve the files named in the URI list for a particular CLID. Furthermore it signals via the call handling process 34A to the signalling stack 30 that the pre-fetching of files 23A . . . 23N is complete and the browser 22A is ready to accept the call.

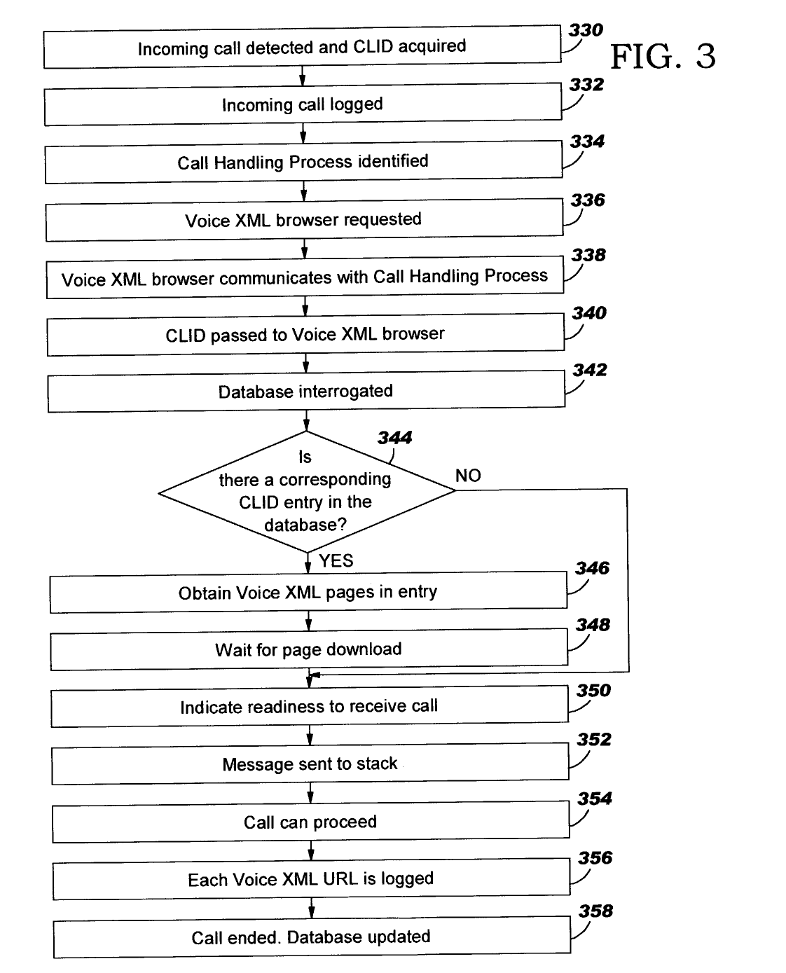

A typical process is now described with reference to FIG. 3.

Step 330. An incoming call is detected by the signalling stack 30. The call is initiated through the transmission of a particular signalling sequence along the physical cable connecting the IVR 10 to the far end switching equipment. The line interface adapter 26 passes the signalling data (including the CLID) via the device driver 28, to the signalling stack 30.

Step 332. The incoming called is logged by the signalling stack 30. The call is kept in a ‘Ringing’ state while the signalling stack 30 notifies the call handling process manager 32 of the incoming call details including the CLID. The caller continues to hear the phone ring.

Step 334. The call handling process manager 32 identifies a free call handling process 34A to process the call and sends the call handling process 34 a message containing the CLID asking it to service the call.

Step 336. The call handling process 34A receives the message and communicates with the VoiceXML browser manager 24 asking for an available VoiceXML browser 22A with which it can communicate.

Step 338. The VoiceXML browser manager 24 communicates with the call handling process to request an available VoiceXML browser 22A

Step 340. The CLID is passed to the Voice XML Browser 22A by the call handling process after communications between the call handling process 34A and the VoiceXML browser 22A are initiated.

Step 342. The database 50 is interrogated by the pre-cache controller 46 to find whether there is already an entry for this CLID.

Step 344. If there is an entry that corresponds to this CLID, the pre-cache controller 46 dispatches fetch threads 44A . . . 44N to obtain the VoiceXML files contained in the entry.

Step 346. The VoiceXML pages are obtained. Each fetch thread 44A . . . 44N checks the file cache 42 to see if its file is already available. If it is, then the fetch thread returns back to the pre-cache controller 40 and makes itself available again. If the requested file is not already in the file cache 42, then the fetch thread goes to the web server specified in the URI to obtain the file. Both VoiceXML applications and VoiceXML components are obtained in this way.

Step 348. The pre-cache controller 46 waits for the file download. The pre-controller 46 observes the status of all the fetch threads 44A . . . 44N that it has dispatched and waits for all to become available again via software callbacks.

Step 350. The pre-cache controller 46 indicates readiness to receive call once it is statified that all the fetch threads 44A . . . 44N have obtained the VoiceXML files required, it sends a message to the call handling process 34A to indicate readiness.

Step 352. The call handling process 34A forwards the message to the signalling stack 30 indicating readiness to receive the call.

Step 354. The telephone phone call can then proceed when the signalling stack 30 receives the message of availability and places the call into a talking state. The boot strap IVR application 25 handles the call to transfer the caller to a chosen IVR application. The bootstrap IVR 25 prompts the caller to choose an IVR application. The chosen IVR is then executed with any delay in downloading it from a web server.

Step 356. Each VoiceXML URI that is visited by the caller during the interaction is noted by the pre-cache controller that attempts to fetch each URI.

Step 358. Once the call has finished the database is updated by the pre-cache controller 46 with the list of favourite URI's for the given CLID based on the previous call.

### EXAMPLE

John Smith picks up his telephone with the intention of dialling into a portal service to VoiceXML applications that are hosted on the Internet.

After dialling the number, John hears the phone ring for a short period.

While the phone is ringing the IVR has noted an incoming call; call handling process 34A and VoiceXML browser 22A are assigned to service John's call.

The VoiceXML browser 22A has also been notified of the number (CLID) from which John is calling and queries the database 50 as to whether there are any favourite sites that John has.

The query from the database 50 comes back with the response that John has not used this service before and hence there are no VoiceXML files 23A . . . 23N that should be pre-fetched.

The VoiceXML browser 22A sends a notification to the signalling stack 30 via the call handling process that it is to take the call.

The signalling stack 30 receives this notification and performs the appropriate actions via the device driver 28 and line interface adapter 26 to signal to the far end switching equipment to answer the call.

John then interacts with the IVR 10 and chooses an IVR application. He visits a pizza ordering site to order dinner and then this banking site to perform some transactions. Finally he visits a mortgage information site to obtain a quote. In each case, he notices a delay before being able to order the pizza, query his bank account and get a mortgage quote. This is due to the VoiceXML browser 22A downloading the VoiceXML application and components during the call. In the case of the pizza ordering site the file 23A is retrieved from ‘http://ibm.com/application.vxml’ and this application references a component 23B at ‘http://ibm.com/component’

During this call, the pre-cache controller 46 has logged the URIs of the applications along with the URIs of any components in the applications that John has visited.

When the call has finished, just before the VoiceXML browser 22A makes itself available again, the pre-cache controller 46 updates the database 50 with a new record for John's CLID that includes a list of the URIs for the 3 sites (including the pizza application 23A and component 23B) that he has just visited.

A few days later, John finds himself to be hungry again, and remembering the pleasant pizza ordering experience he has last time, decides to phone back in to order another.

After having dialled the number, he hears the phone ring. While the phone is ringing this time, the VoiceXML browser 22A has once again received notification of John's CLID and queries the database 50. This time, it receives a notification of the three sites that John visited last time he dialled in. The VoiceXML browser 22A then dispatches fetch threads 44A . . . 44N to get the VoiceXML files for these 3 sites. Notification is also received about corresponding components in each application and other fetch threads are sent to retrieve. Each fetch thread first interrogates the file cache 42 to see whether the file is already available there.

In the case of the pizza ordering site, the file is available so the fetch thread 44A returns immediately. In the other two cases, the files are not available and so each of the fetch threads 32 retrieves the file from the specified URI and saves it in the cache 42. Each of the fetch threads returns. The VoiceXML browser 22A monitors the fetch threads 44A . . . 44N and when they have completed it sends a ready message to the signalling process 30. The signalling stack 30 once again answers the call and John is then able to interact with the IVR 10. This time, there is no delay before he can get to order his pizza. Once the call is finished, the pre-cache controller 46 updates the database record for John's CLID with the pizza ordering URI having a count of 2 (since John has now visited the site twice) and the banking and mortgage site with a count of 1. In subsequent calls, John's record in the database is updated each time to reflect the sites that he visits and the delays presented in John's calls while VoiceXML files are downloaded become fewer.

The embodiment has been described in terms of VoiceXML applications and VoiceXML components but any application with embedded components could be used.

Although the embodiment has been described in terms of IBM WVR for AIX other IVRs can be used to implement the invention. For instance IBM WebSphere Voice Response for Windows* NT* and Windows 2000 with DirectTalk Technology is an interactive voice response (IVR) product that is for users who prefer a Windows-based operating environment to run self-service applications. WebSphere Voice Response is capable of supporting simple to complex applications and can scale to thousands of lines in a networked configuration. *Windows and Windows NT are trademarks of Microsoft Corporation in the United States, other countries, or both.

In summary this invention relates to a call handling solution for IVR applications with embedded components. A method of handling an incoming call in a network connected interactive voice response system (IVR), comprising the steps of: receiving a signal indicating an incoming telephone call with a call identification (CLID); retrieving, from a database, a database record associated with the call identification; retrieving, from a network location identified in the retrieved record, at least one VoiceXML application identified in the retrieved record; storing the retrieved at least one VoiceXML into cache memory; and answering the incoming telephone call.

What is claimed is:

1. A method of handling an incoming call in a network connected interactive voice response system (IVR), comprising the steps of:
receiving a signal indicating an incoming telephone call with a call identification;
retrieving, from a database, a database record associated with the call identification;
retrieving, from a network location identified in the retrieved record, at least one IVR application identified in the retrieved record;
storing the retrieved at least one IVR application into cache memory; and
answering the incoming telephone call.

2. A method as in claim 1 wherein the step of retrieving the at least one IVR application comprises locating an application name in a record used in a previous IVR interaction with respect to the call identification.

3. A method as in claim 2 further comprising the step of adding an IVR application name to the record, said IVR application being involved in the incoming call and not already on the record associated with the call identification.

4. A method as in claim 2 wherein a subset of IVR applications named in the record are retrieved.

5. A method as in claim 4 further comprising updating a count value in the record associated with a IVR application name if the IVR uses the IVR application.

6. A method as in claim 5 wherein the subset of IVR files depends on the count value associated with each application name.

7. The method as in claim 1 wherein the IVR application is a VoiceXML application.

8. The method as in claim 1 further comprising the step of: on answering the call, prompting the caller to choose an IVR application from a plurality of IVR applications including the at least one retrieved IVR application.

9. The method of claim 8 wherein the step of retrieving the at least one IVR application is performed before the step of prompting the caller to choose an IVR application.

10. The method of claim 1 further comprising retrieving, from a network location, at least one IVR application component associated with the IVR application and storing the at least one IVR component into cache memory.

11. The method of claim 10 wherein the at least one IVR component is identified in the retrieved record.

12. A system for handling an incoming call in a network connected interactive voice response system (IVR), comprising:
means for receiving a signal indicating an incoming telephone call with a call identification;
means for retrieving, from a database, a database record associated with the call identification;
means for retrieving, from a network location identified in the retrieved record, at least one IVR application identified in the retrieved record;
means for storing the retrieved at least one IVR application into cache memory; and
means for answering the incoming telephone call.

13. A computer program product for processing one or more sets of data processing tasks in an interactive voice response system (IVR) having cache memory, said computer program product comprising computer program instructions stored on a computer-readable storage medium for, when loaded into a computer and executed, causing a computer to carry out the following steps:
receiving a signal indicating an incoming telephone call with a call identification;
retrieving, from a database, a database record associated with the call identification;
retrieving, from a network location identified in the retrieved record, at least one IVR application identified in the retrieved record;
storing the retrieved at least one IVR application into cache memory; and
answering the incoming telephone call.
